(19) United States
(12) Patent Application Publication
(10) Pub. No.: US 2006/0058075 A1
(43) Pub. Date: Mar. 16, 2006

(54) Communicating object and method of locating such an object

(75) Inventors: Michel Remy, Saint Martin D'Heres (FR); Roland Airiau, Sassenage (FR); Patrice Senn, Grenoble (FR)

Correspondence Address: COHEN, PONTANI, LIEBERMAN & PAVANE, 551 FIFTH AVENUE, SUITE 1210, NEW YORK, NY, 10176, US

(73) Assignee: France Telecom, Paris (FR)

(21) Appl. No.: 11/226,106

(22) Filed: Sep. 14, 2005

(30) Foreign Application Priority Data
Sep. 14, 2004 (FR) 04/09744

(51) Int. Cl. H04M 1/00

(52) U.S. Cl. 455/574; 455/41.2

(57) ABSTRACT

A communicating object comprising long-range wireless communication means, active short-range wireless location means and control means designed, on the one hand, to activate and/or deactivate, at least partly, the power supply for the long-range communication means and, on the other hand, to deactivate, at least partly, the power supply for the short-range location means.

### RELATED APPLICATION

This patent application claims the priority of the French Patent Application No. 04/09744 filed Sep. 14, 2004, the disclosure content of which is hereby incorporated by reference.

### FIELD OF THE INVENTION

The present invention relates to a communicating object of the type used in M2M (Machine To Machine) applications and to a method of locating such an object.

### BACKGROUND OF THE INVENTION

Certain communicating objects are known to those skilled in the art as objects that include an electronic label (also called an active tag or RFID (Radio Frequency Identification) tag) and a power supply (a battery) for supplying this electronic label with power.

Thus, these are distinguished from objects having what are called passive tags which draw the power needed for their operation from the reader that is associated with them.

More precisely, active tags include long-range wireless communication (radio circuit) means that allow them to communicate with other communicating objects or with a connection base station and a microcontroller, designed in particular to activate or deactivate the battery for supplying these wireless communication means with power.

These control means thus make it possible to save power for operating the communicating object by deactivating, or indeed cutting off, the supply to the electronic functions that are not being used during periods of inactivity of the system.

The communicating objects known at the present time have a major drawback in that they cannot be precisely located, that is to say within a few metres.

This problem is all the more critical when the aforementioned wireless communication means have a long range, of the order of a few hundred metres.

### SUMMARY OF THE INVENTION

This problem is solved by the invention. For this purpose, one aspect of the invention relates to a communicating object comprising:
long-range wireless communication means;
first power supply means designed to supply these wireless communication means with power;
active short-range wireless location means;
second power supply means designed to supply the location means with power; and
control means designed to activate and preferably deactivate, at least partly, the first and second power supply means.

Thus, an embodiment of the invention involves precisely locating the communicating object using active short-range wireless location means.

Preferably, the control means for controlling the first and second power supply means are operated by the same microcontroller.

Preferably, the control means activate the second power supply means at a defined instant or after a predetermined period.

Advantageously, this embodiment makes it possible to locate the communicating object at chosen instants.

The position thus obtained may advantageously be communicated to a connection base station using the long-range wireless communication means.

In another preferred embodiment, the control means include a sensor that activates the second power supply means upon detecting a predetermined event.

The communicating object may thus be located as soon as this event occurs.

In a preferred variant of this embodiment, the sensor is designed to detect the movement of the communicating object, using a MEMS (microelectromechanical system) technology of the type used in impact detectors, accelerometers and magnetometers.

In another variant of this preferred embodiment, the sensor is designed to detect a variation in temperature or pressure.

In a preferred embodiment, the long-range wireless communication means include a radiocommunication means using a ULP (ultralow power) technology).

In a preferred embodiment, the active location means include short-distance wireless communication means designed to measure the strength of a signal received by the communicating object from at least three fixed terminals.

Advantageously, these wireless communication means are formed by a communication module in accordance with the WiFi standard, this module being designed to measure the strength of synchronization frame signals transmitted by the fixed terminals.

In an advantageous embodiment variant, this WiFi module is configured so as to operate only in receive mode.

Another aspect of the invention is directed to a method of locating a communicating object as briefly mentioned above, this method comprising:
a step of detecting an event;
a step of activating the second power supply means upon detection of the event; and
a step of locating the communicating object using the active wireless location means.

Since the particular advantages of the location method are identical to those of the abovementioned communicating object, they will not be repeated here.

### BRIEF DESCRIPTION OF THE DRAWINGS

Other aspects and advantages of the present invention will become more clearly apparent on reading the description of the following particular embodiments, this description being given solely by way of non-limiting example and with reference to the appended drawings in which:

FIG. 1 shows a communicating object according to an embodiment of the invention; and

FIG. 2 shows the main steps of a location method according to an embodiment of the invention.

### DETAILED DESCRIPTION OF THE DRAWINGS

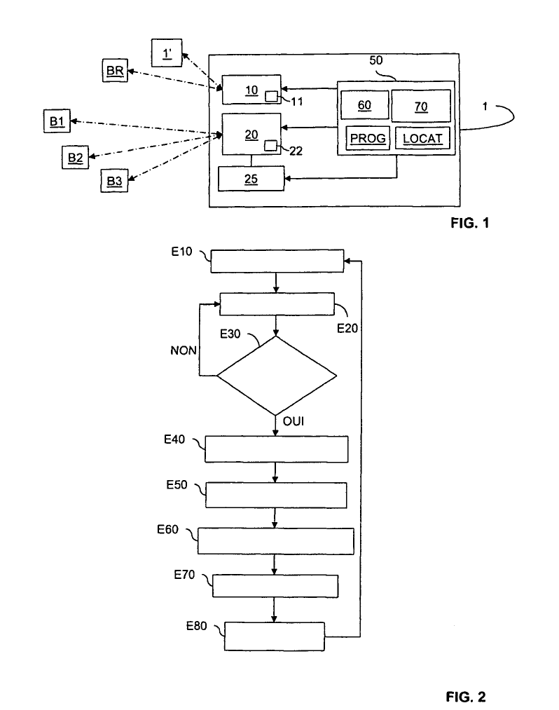

FIG. 1 shows a communicating object 1 according to the invention. The communicating object 1 includes long-range radiocommunication means 10 of the ULP type (Ultra Low Power), allowing it to communicate with another communicating object 1′ or with a connection base station BS.

As those skilled in the art know, these long-range wireless communication means 10 are also called active tags or electronic labels or RFIDs.

In a preferred embodiment, the active long-range wireless communication means consist of the component TR3000 sold by RFM.

These active long-range wireless communication means 10 are supplied with power by first power supply means 11.

In the preferred embodiment described here, the first power supply means 11 consist of a lithium battery known by the reference CR2450.

The communicating object 1 also includes control means 50 designed to activate and deactivate, at least partly, the first power supply means 11.

In the embodiment described here, these control means 50 consist of the microcontroller MPS 430 sold by Texas Instruments.

These control means 50 are more particularly designed so that the power supply for all the electronic circuits or functions not used during the periods of inactivity of the communicating object 1 is placed in stand by mode, or even cut off.

In the preferred embodiment described here, only a timer 60 and a sensor 70 remain continually powered by the first power supply means 11.

According to the invention, the communicating object 1 includes active short-range wireless location means 20 that are supplied with power by second power supply means 25 and allow precise location of the communicating object 1.

In the preferred embodiment described, the active wireless location means consist of the Philips BGW200 circuit programmed only in receive mode.

This circuit thus allows the communicating object 1 to be located on the basis of the measured strength of a signal received from three fixed terminals T1, T2, T3 that regularly transmit (for example every 100 ms) a signal frame, this frame including among other things the MAC address of the fixed terminal that transmitted it.

According to the invention, the control means 50 are designed to activate the second power supply means 25.

In the preferred embodiment described here, the control means 50 are also designed to deactivate the second power supply means 25.

In the example shown in FIG. 1, the second power supply means 25 are external to the active wireless location means 20.

In a variant, the second power supply means 25 are integrated into the wireless location means 20.

In a first embodiment variant, the control means 50 are designed, in cooperation with the timer 60, to activate the second power supply means 25 at a defined instant or after a predetermined period.

It is then possible to locate the communicating object 1 at a given time or at chosen time intervals.

This location data can then be transmitted to the connection base station BS using the active long-range wireless communication means 10.

In another embodiment variant, the sensor 70 activates the second power supply means 25 upon detecting predetermined events.

In the preferred embodiment described here, the sensor 70 uses a MEMS technology and allows the movement of the communicating object 1 to be detected.

Such a MEMS detector may for example consist of the TMA1-02-CSP circuit from Tronics Microsystems.

In another embodiment, the sensor 70 is designed to activate the second power supply means 25 upon detecting a variation in temperature or pressure.

When the control means 50 activate the second power supply means 25 (at a defined instant, after a predetermined period or in response to the sensor 70), the wireless communication module 22 of the active location means 20 measures the received strength of the frame signals transmitted by the three fixed terminals T1, T2, T3.

The communicating object 1 also includes a location table LOCAT for locating the communicating object 1 on the basis of these three strength measurements.

The communicating object 1 also includes means for running a computer program PROG designed to carry out a location method according to the invention, as described below with reference to FIG. 2.

FIG. 2 shows the main steps of a location method according to the invention in a preferred embodiment, this method being implemented by the computer program PROG of the object described above.

This method includes a first step S10 during which the timer 60 of the control means 50 is set to zero.

The zero-setting step S10 is followed by a step S20 during which the control means 50 deactivate the second power supply means 25.

Thus, after this step S20, the active short-range wireless location means 20 are inactive.

The standby step S20 is followed by a test S30 during which a check is made as to whether the timer 60 set to zero at step S10 has expired or whether the sensor 70 has detected an event (movement, variation in temperature or pressure).

If such is not the case, the result of test S30 is NO and the program PROG returns to the previous step S20.

When the timer 60 has expired or when a predetermined event has occurred, the result of test S30 is YES. This test is then followed by a step S40 during which the control means 50 activate the second power supply means 25.

This activation step S40 is followed by a step S50 during which the wireless communication module 22 of the active location means 20 measures the strength of the synchronization frame signals received from the fixed terminals T1, T2, T3 in accordance with the WiFi communication protocol.

The strength measurement step S50 is followed by a step S60 during which the control means 50 deactivate the second power supply means 25.

The deactivation step S60 is followed by a step S70 during which the computer program PROG locates the position of the communicating object 1 by reading from the location table LOCAT indexed by the three measured strength levels.

The location step S70 is followed by a step S80 during which the position thus obtained is transferred to the connection base station BS or to another communicating object 1′ via the long-range wireless communication means 10.

As a variant, the active long-range wireless communication means may be means of communication according to a GSM, GPRS or UMTS protocol.

Also as a variant, the active short-range wireless location means may be in accordance with Bluetooth technology.

In the representation shown in FIG. 1, the first power supply means 11 and the second power supply means 25 appear as separate elements.

A person skilled in the art will understand that these elements may indeed be formed by two separate elements, as shown in FIG. 1, but also by one and the same power supply designed to supply power, independently or simultaneously, to the long-range wireless connection means 10 and to the active wireless location means 20 depending on the activation/deactivation control signals received from the control means 50.

1. A communicating object, comprising:
long-range wireless communication means; and
first power supply means designed to supply the said communication means with power;
active short-range wireless location means;
second power supply means designed to supply the said active location means with power; and
control means designed to activate and preferably deactivate, at least partly, said first and second power supply means.

2. The communicating object according to claim 1, wherein said control means for controlling the first and second power supply means are operated by the same microcontroller.

3. The communicating object according to claim 1, wherein said control means are designed to activate the second power supply means at a defined instant or after a predetermined period.

4. The communicating object according to claim 1, wherein said control means include a sensor designed to activate the second power supply means upon detecting a predetermined event.

5. The communicating object according to claim 4, wherein said sensor is designed to activate the second power supply means upon detecting a movement of the said communicating object.

6. The communicating object according to claim 5, wherein said sensor uses a MEMS technology.

7. The communicating object according to claim 4, wherein said sensor is designed to activate the second power supply means upon detecting a variation in temperature or pressure.

8. The communicating object according to claim 1, wherein the long-range wireless communication means include a ULP radiocommunication module that communicates with a connection base station or with another communicating object.

9. The communicating object according to claim 1, wherein the active location means include communication means designed to measure the strength of a signal received from at least three fixed terminals.

10. The communicating object according to claim 9, wherein the location means comprise a short-distance wireless communication module designed to measure the strength of synchronization frame signals transmitted by the said fixed terminals, in accordance with the WiFi communication protocol.

11. A method of locating a communicating object according to claim 1, comprising:
a step of detecting an event;
a step of activating the said second power supply means upon detection of said event; and
a step of locating said communicating object using said active wireless location means.

12. The location method according to claim 11 wherein, during said detection step, said event corresponds to:
the start of a predetermined instant; or
the expiry of a predetermined period; or
a movement of said communicating object; or
a variation in temperature or pressure.

13. The location method according to claim 11, wherein in order for said location step to be carried out, said wireless location means measure the strength of a signal received from at least three fixed terminals.

14. The location method according to claim 13, wherein in order for said location step to be carried out, said wireless location means measure the strength of synchronization frame signals transmitted by said fixed terminals, in accordance with the WiFi communication protocol.
